(19) United States
(12) Patent Application Publication
(10) Pub. No.: US 2015/0295719 A1
(43) Pub. Date: Oct. 15, 2015

(54) Methods, apparatuses & computer program products for facilitating electronic submission of national letter of intent/scholarship

(71) Applicant: Eugene Byrd, Vestavia Hill, AL (US)

(72) Inventor: Eugene Byrd, Vestavia Hill, AL (US)

(21) Appl. No.: 14/544,766

(22) Filed: Jan. 20, 2012

(51) Int. Cl. H04L 9/32

(52) U.S. Cl. CPC H04L 9/3247

(57) ABSTRACT

Esigningday electronic signature and processing database follows the same path established by the NCAA for legitimizing the signature process of the NLI and scholarship letter, with the added speed of electronic processing. The Esigningday electronic process in secure and valid according to the Federal E-Sign Act of 2000, which states that electronic signature are equivalent to written signatures. Since the process is electronic, data is available in real-time. This feature allows coaches, athletic administrator and the conference office the ability to access instant details regarding the acceptance of prospective student-athletes instead of waiting for paper documents to be returned.

### FIELD OF THE INVENTION

Exemplary embodiments of the present invention relate generally to the electronic signing of documents, and more particularly concerns a network-based process and system allowing the legally enforceable signing of documents in the field of college athletics relating to the National Letter of Intent and the Scholarship Letter in a network environment, which may not require a user of a communication device to install any special signing software on his/her communication device or system. This network-based paperless process and system may store and process electronic signatures and documents at the click of a button.

### BACKGROUND

In the Web e-commerce world, physical handwritten signatures are often considered an unnecessary burden to a process that users expect to be fast, easy, and reliable. The current system of signing the National Letter of Intent and Scholarship Letter typically requires users to download and print documents, physically sign them and manually send the signed documents back to all parties involved by mail (e.g., express mail). This may result in added delays, increased costs, additional manual processing on the part of an institution (e.g., University/College), and lack of institutional control. Additionally, one or more documents may be lost by one or more parties involved in the process and in this regard some previously performed tasks may need to be repeated. This may present additional burdens to parties involved in the process of handling the submission of the National Letter of Intent and Scholarship Letter to an Institution.

In view of the foregoing drawbacks, it may be beneficial to provide a mechanism in which Institutions may enable Institution Administrators, Coaches, Student-Athletes, and Parents/Guardians to review and legally sign the National Letter of Intent and Scholarship Letter agreeing the Student-Athlete will in fact attend the respective institution for one academic year directly and in real-time electronically via a communication device, where users may only need a access to a network in order to complete the transaction as quickly and efficiently as possible.

### BRIEF SUMMARY

The purpose of the Esigningday network based (e.g., web based) electronic signature, storage, and processing of the National Letter of Intent and Scholarship Letter is to save time and money for participating Institutions. This network-based (e.g., web based) system requires network access (e.g., Internet access) to allow Athletic Administrator, Financial Aid Administrator, Compliance Administrator, Sports, Coaches, and Conference Office, Prospective Student-Athlete, and Parent to electronically sign, store, and process the National Letter of Intent and Scholarship Letter using any device with internet access (e.g., computer, smartphone, mobile tablet, laptop, iPad, and the like). By utilizing an Esigningday module in a network environment, the exemplary embodiments may eliminate the time and cost of the current paper based process by replacing this process with a legally supported document processing system.

### BRIEF DESCRIPTION OF THE SEVERAL VIEWS OF THE DRAWINGS

In the course of describing various aspects of the invention, the current application will refer to the drawings described below, which are not necessarily drawn to scale, and wherein:

FIG. 1 is schematic block diagram of an electronic device according to an exemplary embodiment of the invention; and

FIG. 2 is a flowchart of a method according to an exemplary embodiment of the invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As referred to herein, “electronic signing,” e-signature,” “electronic signature” or the like may, but need not, refer to electronic signatures denoted by an electronic sound, a symbol(s), or process(es), attached to or logically associated with a contract(s) or other record(s) and executed or adopted by a person with the intent to sign the record(s). Therefore, an electronic signature as referred to herein may be represented by one's name that is typed into a document (e.g., Microsoft Word™ document) or by clicking on an “I Agree” button at the end of a series of web pages, for example, as long as the act of signing is somehow attached to or associated with the contract(s), document(s), record(s) or the like and with the signature of a respective person.

Either of these methods may be ideal to sign the National Letter of Intent and Scholarship Letter using an Electronic Signing module (also referred to herein as Esigningday module), which may be assessable via a network such as, for example, a Web site, portal or the like. However, without security to protect the National Letter of Intent and Scholarship Letter it may not be considered reliable and the National Letter of Intent and Scholarship Letter may not be legally enforceable. An exemplary embodiment of the invention may provide the equivalent of a legally-enforceable “I Agree” button, a typed name, and may create a signature by drawing. This signing process of an exemplary embodiment of the invention may be secured through technology and/or other means without the complexity of issuing one or more digital certificates to each user who needs to sign and then having to manage all these digital certificates.

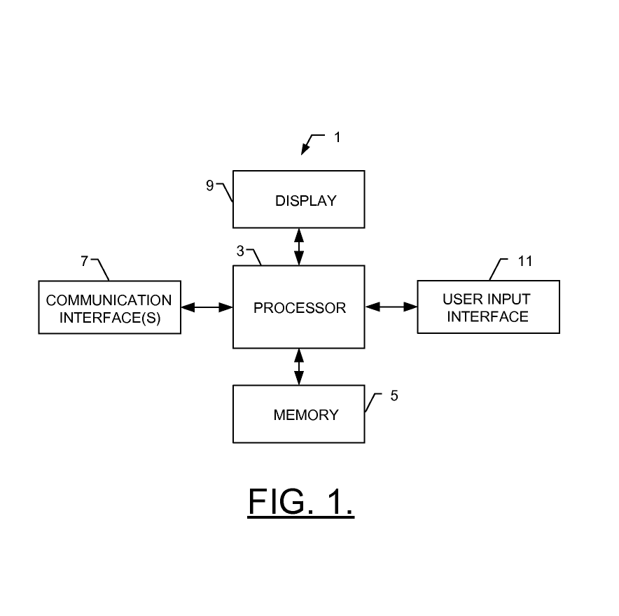

FIG. 1 illustrates a block diagram of an electronic device 1 (also referred to herein interchangeably as Esigningday module or alternatively Electronic signing module) according to an exemplary embodiment of the invention. The electronic device 1 may be configured to operate as a client, server, computing device, mobile terminal, cellular phone or the like, in accordance with one embodiment. The electronic device may include various means for performing one or more functions in accordance with exemplary embodiments described herein including those more particularly shown and described herein. It should be understood, however, that one or more of the electronic devices may include alternative means for performing one or more like functions, without departing from the spirit and scope of the present invention. More particularly, for example, as shown in FIG. 1, the electronic device may include a processor 3 connected to a memory 5. The memory may comprise volatile and/or non-volatile memory, and may store content, data or the like. For example, the memory may store content transmitted from, and/or received by, the entity. The memory may be capable of storing data including but not limited to documents for electronic signature. Also, for example, the memory may store client applications, instructions or the like for the processor 3 to perform steps associated with operation of the electronic device in accordance with embodiments described herein. As explained below, for example, the memory can store one or more client application(s) such as, for example, software associated with the generation of the one or more National Letters of Intent and/or Scholarship letters.

The electronic device may include one or more logic elements for performing various functions of one or more client application(s). The logic elements performing the functions of one or more client applications can be embodied in an integrated circuit assembly including one or more integrated circuits integral or otherwise in communication with a respective network entity (e.g., computing system, client, server, etc.) or more particularly, for example, a processor 3 of a particular network entity.

In addition to the memory 5, the processor 3 can also be connected to at least one interface or other means for displaying, transmitting and/or receiving data, content or the like. The interface(s) can include at least one communication interface 7 or other means for transmitting and/or receiving data, content or the like. In this regard, the communication interface 7 may include, for example, an antenna and supporting hardware and/or software for enabling communications with a wireless communication network. For example, the communication interface(s) can include a first communication interface for connecting to a first network, and a second communication interface for connecting to a second network. In this regard, the entity is capable of communicating with other electronic devices over a network such as a Local Area Network (LAN), Wide Area Network (WLAN), Wireless Wide Area Network (WWAN), the Internet, or the like. Alternatively, the communication interface may support a wired connection with the respective network. In addition to the communication interface(s), the interface(s) can also include at least one user interface that can include one or more earphones and/or speakers, a display 9 and/or a user input interface 11.

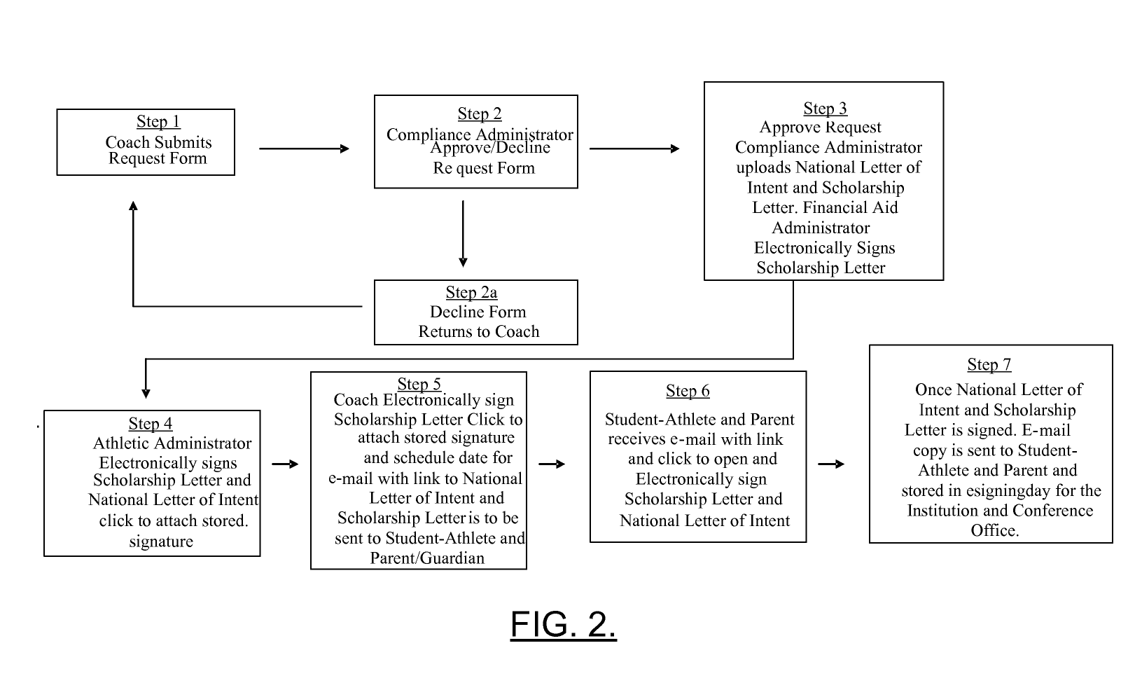

The Esigningday module (e.g., electronic device 1) may enable schools/institutions to register to participate in a network based (e.g., Web based), paperless signing, sending, processing and storage system of the National Letter of Intent and Scholarship Letter. This network based (e.g., Web based) system may streamlines the existing time consuming, burdensome, and costly paper based system of signing and processing the National Letter of Intent and Scholarship Letter to make it paperless, quick, and an efficient process that reduces both personal time and costs. Institutions may register for usage of the esigningday services, provided by the Esigningday module, by completing an application. The institution may select an Athletic Administrator(s), Financial Aid Administrator(s), Compliance Administrator(s), Sports, Coaches, and Conference Office(s). Once the institution is registered for esigningday services the network based (e.g., Web based) electronic signature, processing, and storage system provided by the Esigningday module may facilitate implementation of the following steps as shown in FIG. 2:

Step 1. A coach(es) may sign in to his/her account set-up on via the Esigningday module (e.g., based on a web environment). The coach may submit a request form for the National Letter of Intent and Scholarship Letter to the declared Compliance Administrator for the Institution via the Esigningday module (e.g., in said web environment).
Step 2. The Institution's Compliance Administrator may receive a notification (e.g., email notification) of a pending National Letter of Intent and Scholarship Letter request form. The Compliance Administrator may sign in to his/her account set-up via the Esigningday module (e.g., in a web environment) and may have the option to approve or decline (Step 2a.) the coach's request form. If the request form is approved the Compliance Administrator may upload the National Letter of Intent and Scholarship Letter to be stored in the memory 5 in the Student-Athlete's file (e.g., via a web environment).
Step 3. The Institution's Financial Aid Administrator may receives a notification (e.g., email notification) to electronically sign the Scholarship Letter uploaded by the Compliance Administrator via the Esigningday module (e.g., in a web environment). The Financial Aid Administrator may signs in to his/her account set-up in via the Esiginingday module to electronically sign the approved Scholarship Letter.
Step 4. The Institution's Athletic Administrator may receive a notification (e.g., email notification) to electronically sign the National Letter of Intent and Scholarship Letter via the Esigningday module. The Athletic Administrator may sign in to his/her account set-up by the Esigningday module to electronically sign the approved National Letter of Intent and Scholarship Letter.
Step 5. The Institution's Coach may receive a notification (email notification) to electronically sign the Scholarship Letter. The Coach may sign in to his/her account set-up by the Esigningday module to electronically sign the approved Scholarship Letter. Once signed by all of the necessary individuals from the Institution, the Coach may schedule the date and time within the signing period parameters set by the National Collegiate Athletic Association (NCAA) for each individual sport for a message (e.g., email message, short message service (SMS) message, etc.) to be sent to the prospective Student-Athlete and the Parent to sign in which the message may include a link to access the Esigningday module (e.g., via a web environment where the National Letter of Intent and Scholarship Letter may be stored for them to electronically sign.
Step 6. The prospective Student-Athlete and/or the Parent/Guardian may select the link in the message (e.g., e-mail message) to access the Esigningday module (e.g., via a web environment) which may enable the Student-Athlete and/or the Parent/Guardian to electronically sign the document(s) (e.g. a National Letter of Intent and/or Scholarship letter) at the appropriate time. A message may be sent to an electronic device of the coach to notify him/her of the Student-Athlete and Guardian/Parent's acceptance by electronic signature via the Esigningday module (e.g., a web environment) of the National Letter of Intent and Scholarship Letter indicating the signing of the documents and the documents placement in a storage (e.g., memory 5) The Student-Athlete and Parent may receive a message (e.g., email message), via an electronic device, that includes a copy of the electronically signed National Letter of Intent and Scholarship Letter for their records.
Step 7. The electronically signed National Letter of Intent and Scholarship Letter may be stored in a memory (e.g. memory 5) of the Esigningday module) and may be available for the Conference Office Administrator to electronically validate within the 21 days of issuance via the Esigningday module.

It should be pointed out that FIG. 2 is a flowchart of a system, method and computer program product according to exemplary embodiments of the invention. It will be understood that each block or step of the flowchart, and combinations of blocks in the flowchart, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above may be stored by a memory device (e.g., memory 5) and executed by a processor (e.g., processor 3). As will be appreciated, any such computer program instructions may be loaded onto a computer or other programmable apparatus (e.g., hardware) to produce a machine, such that the instructions which execute on the computer or other programmable apparatus cause the functions specified in the flowchart blocks or steps to be implemented. In some embodiments, the computer program instructions are stored in a computer-readable memory that can direct a computer or other programmable apparatus to function in a particular manner, such that the instructions stored in the computer-readable memory produce an article of manufacture including instructions which implement the function specified in the flowchart blocks or steps. The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart blocks or steps.

Accordingly, blocks or steps of the flowchart support combinations of means for performing the specified functions and combinations of steps for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

### Inventive Concepts

The Esigningday module electronic signature and storage system may enable a processor (e.g., processor 3) to process the National Letter of Intent and Scholarship Letter via a network (e.g., Internet). The Esigningday module may require access to a network (e.g., Internet) and may allow schools/institutions to streamline their existing time consuming, burdensome, and costly paper based system of signing and processing the National Letter of Intent and Scholarship Letter to make it a paperless, quick, and efficient process that reduces both personal time and cost using any communication device with network (e.g., Internet) access (e.g., a computer, smartphone, mobile tablet, laptop, iPad, and the like).

1. The Esigningday electronic signature and storage web environment processes the National Letter of Intent and Scholarship Letter using the Internet. Said web environment requires Internet access and allows schools to streamline their current time consuming, burdensome, and costly paper based system of signing and processing the National Letter of Intent and Scholarship Letter to make it paperless, quick, and efficient, process that reduces both personal time and cost using any device with internet access (a.k.a. computer, smartphone, mobile tablet, laptop, iPad, and the like).
